(19) United States
(12) Patent Application Publication
(10) Pub. No.: US 2006/0070780 A1
(43) Pub. Date: Apr. 6, 2006

(54) Power supply device for a power-driven wheelbarrow

(75) Inventor: Paul Lin, Yung-Kang City (TW)

Correspondence Address: Ladas & Parry, Suite 2100, 5657 Wilshire Boulevard, Los Angeles, CA, 90036-5679, US

(73) Assignee: MACAUTO INDUSTRIAL CO., LTD.

(21) Appl. No.: 10/948,930

(22) Filed: Sep. 24, 2004

(51) Int. Cl. B60R 16/04

(52) U.S. Cl. 180/68.5

(57) ABSTRACT

A power supply device for a power-driven wheelbarrow includes a housing, a battery unit and an electrical connector unit. The housing includes a housing body adapted for mounting on the wheelbarrow and formed with an open end. The battery unit is inserted removably into the housing body via the open end, and is provided with a set of first battery contacts. The electrical connector unit is mounted to the housing body, and includes a set of second battery contacts for mating with the first battery contacts, and an output connector adapted for connecting electrically with the wheelbarrow such that electric power of the battery unit is supplied to the wheelbarrow via the electrical connector unit.

### BACKGROUND OF THE INVENTION

1. Field of the Invention

The invention relates to a power supply device, more particularly to a power supply device for a power-driven wheelbarrow.

2. Description of the Related Art

A conventional power-driven wheelbarrow generally includes a frame, a bucket mounted on top of the frame, a power-driven wheel unit mounted to a front portion of the frame, and a rechargeable storage battery mounted on the bottom side of the frame. The storage battery supplies electric power to the wheel unit, thereby enabling rotation of the wheel unit to assist an operator in advancing the wheelbarrow.

In the conventional power-driven wheelbarrow, the storage battery is not designed for easy removal from the frame. Thus, when it is desired to recharge the storage battery, the entire wheelbarrow must be moved to the vicinity of a charging station. This arises in inconvenience, especially when the charging station is far away, or when the wheelbarrow has to be maneuvered through a narrow path in order to reach the charging station.

### SUMMARY OF THE INVENTION

Therefore, the object of the present invention is to provide a power supply device for a power-driven wheelbarrow that can overcome the aforesaid drawbacks of the prior art.

According to the present invention, a power supply device for a power-driven wheelbarrow comprises a housing, a battery unit, and an electrical connector unit. The housing includes a housing body adapted for mounting on the wheelbarrow and formed with an open end. The battery unit is inserted removably into the housing body via the open end, and is provided with a set of first battery contacts. The electrical connector unit is mounted to the housing body, and includes a set of second battery contacts for mating with the first battery contacts, and an output connector adapted for connecting electrically with the wheelbarrow such that electric power of the battery unit is supplied to the wheelbarrow via the electrical connector unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic side view of a power-driven wheelbarrow that incorporates the preferred embodiment of a power supply device according to the present invention;

FIG. 2 is a schematic top view of the power-driven wheelbarrow of FIG. 1;

FIG. 3 is a partly exploded, perspective view of the preferred embodiment; and

FIG. 4 is an assembled perspective view of the preferred embodiment.

### DETAILED DESCRIPTION OF THE PREFERRED EMBODIMENT

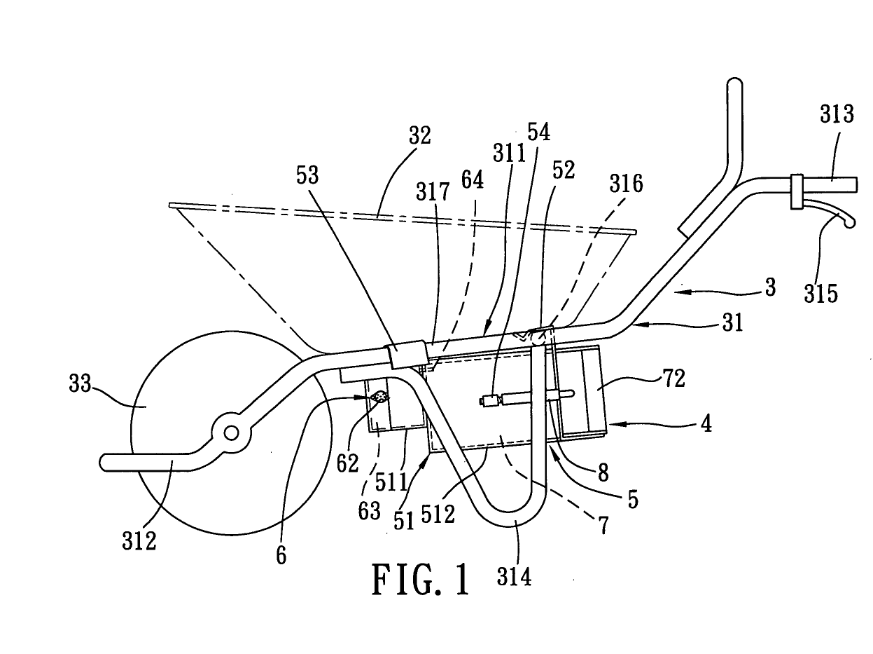

Referring to FIGS. 1 to 3, the preferred embodiment of a power supply device 4 according to this invention is shown to be adapted for use with a power-driven wheelbarrow 3. The wheelbarrow 3 includes a frame 31, a bucket 32, and a power-driven wheel unit 33. The frame 31 has an intermediate frame part 311 for mounting the bucket 32 thereon, a wheel mounting part 312 that extends forwardly and downwardly from the intermediate frame part 311 for mounting the wheel unit 33 thereon, two handle parts 313 that extend rearwardly and upwardly from the intermediate frame part 311, and two supports 314 that extend downwardly from the intermediate frame part 311 for supporting the wheelbarrow 3 when the latter is at rest. A power control unit 315 is provided on one of the handle parts 313, and is operable so as to control supply of electric power from the power supply device 4 to the wheel unit 33 in a conventional manner.

The power supply device 4 includes a housing 5 mounted to the intermediate frame part 311 and disposed under the bucket 32, an electrical connector unit 6 mounted to the housing 5, a battery unit 7 inserted removably into the housing 5, and a stop member 8 mounted on the housing 5 and operable so as to arrest undesired outward movement of the battery unit 7 in the housing 5.

The housing 5 includes a housing body 51, a rear hook 52 that extends forwardly from a rear top edge of the housing body 51, two side hooks 53 that open downwardly and that are fixed respectively to opposite outer lateral sides of a front end portion 511 of the housing body 51, and a nut 54 that is fixed to one of the outer lateral sides of the housing body 51. In this embodiment, the housing body 51 is a generally rectangular body formed with a rear open end. In addition, the front end portion 511 is slightly smaller than a rear end portion 512 of the housing body 51.

The housing 5 is assembled to the frame 31 before the bucket 32 is mounted on top of the intermediate frame part 311. To assemble the housing 5, the rear hook 52 is hooked onto a rear frame section 316 of the intermediate frame part 311, and the side hooks 53 are subsequently hooked onto side frame segments 317 of the intermediate frame part 311. Thereafter, when the bucket 32 is mounted on the intermediate frame part 311, the bucket 32 pushes the housing 5 downwardly and prevents upward removal of the housing 5 from the frame 31.

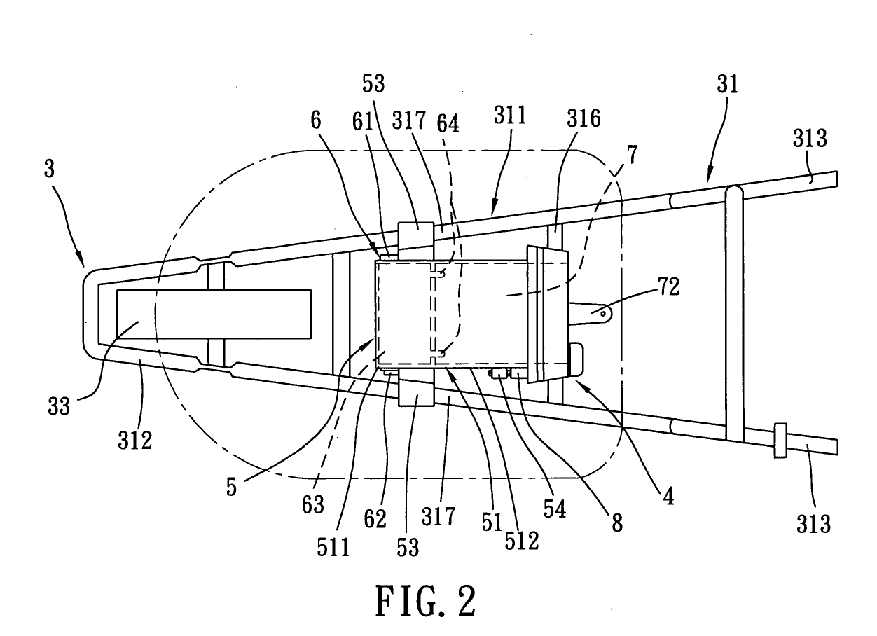

The electrical connector unit 6 includes an input connector 61 (see FIG. 2) and an output connector 62 that are respectively accessible from the opposite outer lateral sides of the front end portion 511 of the housing body 51, a control circuit 63 mounted in the front end portion 511 of the housing body 51 and connected electrically to the input and output connectors 61, 62, and a pair of male battery contacts 64 that are connected electrically to the control circuit 63 and that extend into the rear end portion 512 of the housing body 51.

The battery unit 7 includes a battery case 71 that is inserted removably into the rear end portion 512 of the housing body 51 via the rear open end of the housing body 51, a handle 72 provided on a rear end of the battery case 71 to facilitate insertion and removal of the battery case 71 from the housing body 51, and a rechargeable storage battery 73 disposed in the battery case 71. The battery case 71 is provided with a pair of female battery contacts 711 that are connected electrically to positive and negative battery electrodes (not shown) of the storage battery 73. When the battery case 71 is inserted into the rear end portion 512 of the housing body 51, the male battery contacts 64 mate respectively with the female battery contacts 711, thereby coupling electrically the control circuit 63 to the storage battery 73.

It should be noted herein that the battery case 71 is not essential to the practice of this invention. In case there is no battery case 71, the storage battery 73 is inserted directly into the rear end portion 512 of the housing body 51.

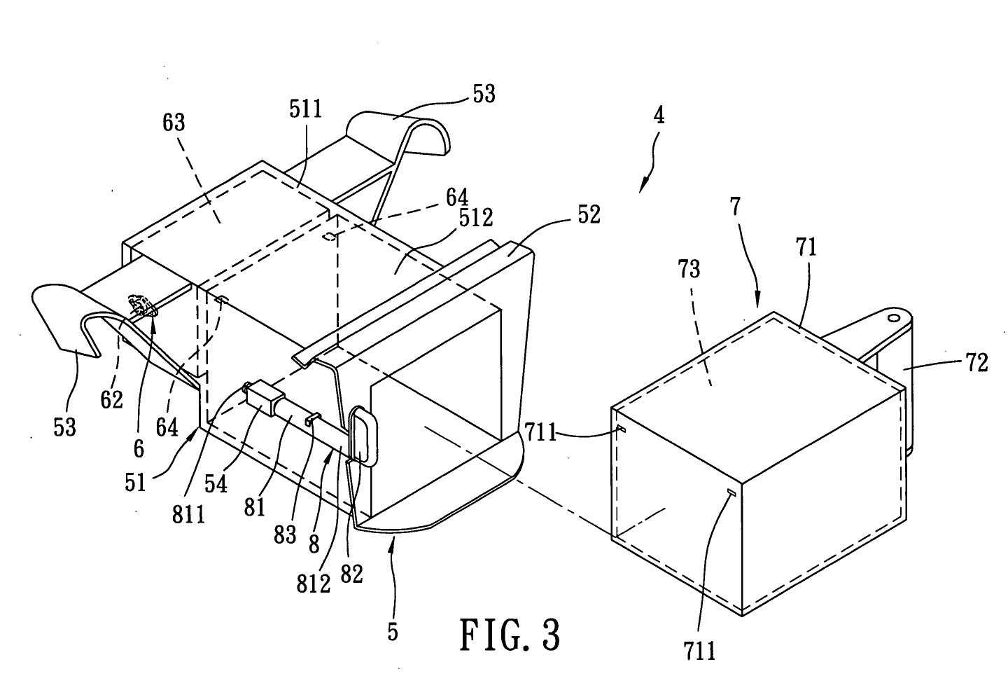

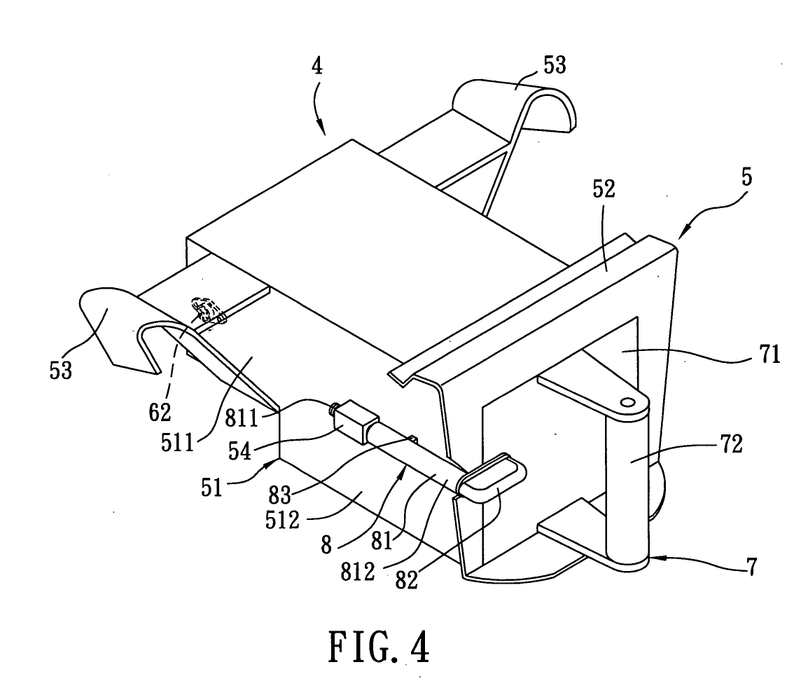

The stop member 8 includes a pivot rod section 81 having an externally threaded first end 811 and a second end 812 opposite to the first end 811, a stop section 82 extending in a transverse direction from the second end 812 of the pivot rod section 81, and a limit rib 83 formed on the pivot rod section 81 between the first and second ends 811, 812. The first end 811 of the pivot rod section 81 engages threadedly the nut 54 on the housing body 51. Due to the threaded engagement with the nut 54, the pivot rod section 81 can be rotated relative to the housing body 51 so as to dispose the stop section 82 in one of a blocking position shown in FIG. 4, where the stop section 82 is disposed rearwardly of the battery unit 7 in the housing body 51 and blocks removal of the battery unit 7 from the housing body 51, and an unblocking position shown in FIG. 3, where the stop section 82 permits insertion and removal of the battery unit 7 from the housing body 51. When the pivot rod section 81 is rotated to dispose the stop section 82 at the blocking position, the limit rib 83 frictionally engages the housing body 51 to arrest further rotation of the pivot rod section 81, thereby retaining releasably the stop section 82 at the blocking position.

When it is desired to charge the storage battery 73 while the power supply device 4 is on the wheelbarrow 3, the wheelbarrow 3 is first moved to the vicinity of a charging station (not shown) to permit connection of the control circuit 63 to the charging station via the input connector 61. The control circuit 63 then processes a charging signal received from the charging station via the input connector 61, and manages charging operation of the storage battery 73 via the female and male battery contacts 711, 64 (i.e., first and second battery contacts).

When it is desired to operate the wheel unit 33, the power control unit 315 is connected to the control circuit 63 via the output connector 62. The control circuit 63 then responds to operation of the power control unit 315 in a conventional manner to control supply of electric power to the wheel unit 33.

Unlike the prior art, it is possible to recharge the storage battery 73 of the power supply device 4 without moving the wheelbarrow 3 to the charging station. In this case, the battery unit 7 is simply removed from the housing 5, and only the battery unit 7 is brought to the charging station for charging the storage battery 73.

Because recharging of the battery unit 7 is possible upon removal from the housing 5, it is apparent that the input connector 61 and the control circuit 63 may be dispensed with in other embodiments of the present invention.

It has thus been shown that the power supply device 4 of this invention permits recharging of the battery unit 7 without the need to move the wheelbarrow 3 to the vicinity of a charging station, thereby eliminating the aforesaid inconvenience encountered in the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A power supply device for a power-driven wheelbarrow, comprising:
a housing including a housing body adapted for mounting on the wheelbarrow and formed with an open end;
a battery unit inserted removably into said housing body via said open end, and provided with a set of first battery contacts; and
an electrical connector unit mounted to said housing body and including a set of second battery contacts for mating with said first battery contacts, and an output connector adapted for connecting electrically with the wheelbarrow such that electric power of said battery unit is supplied to the wheelbarrow via said electrical connector unit.

2. The power supply device as claimed in claim 1, further comprising a stop member mounted on said housing body and operable so as to arrest undesired outward movement of said battery unit in said housing body.

3. The power supply device as claimed in claim 2, wherein said stop member includes:
a pivot rod section having a first end coupled threadedly to said housing body, and a second end opposite to said first end; and
a stop section extending in a transverse direction from said second end of said pivot rod section;
said pivot rod section being rotatable relative to said housing body so as to dispose said stop section in one of a blocking position, where said stop section blocks removal of said battery unit from said housing body, and an unblocking position, where said stop section permits insertion and removal of said battery unit from said housing body.

4. The power supply device as claimed in claim 3, wherein said stop member further includes a limit rib formed on said pivot rod section between said first and second ends, said limit rib frictionally engaging said housing body to arrest further rotation of said pivot rod section so as to retain releasably said stop section at the blocking position when said pivot rod section is rotated to dispose said stop section at the blocking position.

5. The power supply device as claimed in claim 3, wherein said housing body is provided with a nut to couple threadedly with said first end of said pivot rod section.

6. The power supply device as claimed in claim 1, wherein:
said battery unit further includes a rechargeable storage battery connected electrically to said first battery contacts;
said electrical connector unit further including an input connector for receiving a charging signal, and a control circuit mounted in said housing body and connected electrically to said input and output connectors and said second battery contacts, said control circuit managing charging operation of said storage battery via said first and second battery contacts upon receipt of the charging signal.

7. The power supply device as claimed in claim 1, wherein said battery unit includes a battery case that is inserted removably into said housing body, a handle provided on said battery case to facilitate insertion and removal of said battery case from said housing body, and a storage battery disposed in said battery case, said second battery contacts being provided on said battery case and being connected electrically to said storage battery.

8. The power supply device as claimed in claim 7, wherein said storage battery is rechargeable.

9. The power supply device as claimed in claim 1, wherein said housing further includes a set of hooks formed on said housing body and adapted for hooking onto the wheelbarrow.
